(19) United States
(12) Patent Application Publication
(10) Pub. No.: US 2025/0371499 A1
(43) Pub. Date: Dec. 4, 2025

(54) INFORMATION PROCESSING METHOD, APPARATUS, DEVICE AND MEDIUM

(71) Applicant: Beijing Zitiao Network Technology Co., Ltd., Beijing (CN)

(72) Inventors: Xin TAO, Beijing (CN); Hailong LI, Beijing (CN)

(21) Appl. No.: 18/867,419

(22) PCT Filed: Jun. 5, 2023
(86) PCT No.: PCT/CN2023/098258

§ 371 Date: Nov. 19, 2024

(30) Foreign Application Priority Data
Jun. 23, 2022 (CN) 202210720206.6

(51) Int. Cl. G06Q 10/10

(52) U.S. Cl. CPC G06Q 10/103

(57) ABSTRACT

The present disclosure discloses an information processing method, apparatus, device and medium. When a first user needs to introduce a third party into a first client used by himself, a second user as a third party sends a service order to the first client of the first user through a second client, the service order including an identifier of the second user, an identifier of the first user and a service personnel list. After receiving the service order, in response to the service order taking effect, establishing an association between the second user and the first user, the association instructing a service personnel in the service personnel list is able to provide services for the first user in the first client as a collaborator.

### CROSS-REFERENCE TO RELATED APPLICATIONS

The present application is a U.S. National Stage application under 35 U.S.C. § 371 of International Application No. PCT/CN2023/098258, as filed on Jun. 5, 2023, which claims the benefit of priority to the CN patent for invention application Ser. No. 20/221,0720206.6, entitled “INFORMATION PROCESSING METHOD, APPARATUS, DEVICE AND MEDIUM” filed with the China National Intellectual Property Administration on Jun. 23, 2022, the disclosure of which is hereby incorporated by reference in its entirety into the present application.

### TECHNICAL FIELD

The present application relates to the technical field of computer, and in particular to an information processing method, apparatus, device and medium.

### BACKGROUND

In an enterprise, in order to facilitate communication between employees, an enterprise collaborative work software will be configured, so that employees can communicate and cooperate between two or more people in real time through a client that is installed with the collaborative work software. Collaborative work software refers to a suite of software that integrates any number of functions including address book, instant messaging tool, conference, cloud document, workbench, email, calendar and integrated platform.

Since there are many functions integrated in the collaborative work software, the learning cost for some functions can be high; in order to make quick use of such functions, some enterprises will make it do by introducing a third party as assistance.

### SUMMARY OF THE INVENTION

In view of this, an embodiment of the present application provides an information processing method, apparatus, device and medium.

In order to achieve the above objective, the present application provides a technical solution as follows:

In a first aspect of the present application, there is provided an information processing method, the method comprising:
receiving a service order sent by a second client, the service order comprising an identifier of a first user, an identifier of a second user, and a service personnel list, the first client corresponding to the first user, the second client corresponding to the second user, the second user providing services for the first user;
in response to the service order taking effect, establishing an association between the second user and the first user, the association instructing a service personnel in the service personnel list is able to provide services to the first user in the first client as a collaborator.

In a second aspect of the present application, there is provided an information processing method, the method comprising:
generating a service order, the service order comprising an identifier of a first user, an identifier of a second user, and a service personnel list, the second user corresponding to the second client, the second user providing services for the first user;
sending the service order to a first client corresponding to the first user.

In a third aspect of the present application, there is provided an information processing apparatus, the apparatus comprising:
a receiving unit configured for receiving a service order sent by a second client, the service order comprising an identifier of a first user, an identifier of a second user, and a service personnel list, the first client corresponding to the first user, the second client corresponding to the second user, the second user providing services for the first user;
an establishing unit configured for, in response to the service order taking effect, establishing an association between the second user and the first user, the association instructing a service personnel in the service personnel list is able to provide services to the first user in the first client as a collaborator.

In a fourth aspect of the present application, there is provided an information processing apparatus, characterized in that the apparatus comprises:
a generating unit configured for generating a service order, the service order comprising an identifier of a first user, an identifier of a second user, and a service personnel list, the second user corresponding to the second client, the second user providing services for the first user;
a sending unit configured for sending the service order to a first client corresponding to the first user.

In a fifth aspect of the present application, there is provided an electronic device comprising: a processor and a memory;
wherein the memory is configured for storing an instruction or a computer program;
and the processor is configured for executing the instruction or computer program in the memory, to cause the electronic device to implement the method according to the first aspect or the second aspect.

In a sixth aspect of the present application, there is provided a computer-readable storage medium, in which instructions are stored, which instructions, when executed on a device, causes the device to implement the method according to the first aspect or the second aspect.

In a seventh aspect of the present application, there is provided a computer program product comprising computer program/instructions which, when executed by a processor, implements the method according to the first aspect or the second aspect.

### BRIEF DESCRIPTION OF THE DRAWINGS

The drawings attached thereto are intended to provide further understanding of the present disclosure, which drawings constitute part of the description, and together with the embodiments of the present disclosure, serve to interpret the present disclosure and do not constitute limitation over the present disclosure. In the drawings:

FIG. 1 is a flowchart of an information processing method provided by an embodiment of the present application;

FIG. 2a is a schematic diagram of a new service order provided by an embodiment of the application;

FIG. 2b is a schematic diagram of a state transition of service personnel provided by an embodiment of the present application;

FIG. 2c is a schematic diagram of state transition of a service order provided by an embodiment of the present application;

FIG. 3 is a schematic diagram of an information processing application scenario provided by an embodiment of the present application;

FIG. 4 is a flowchart of another information processing method provided by an embodiment of the present application;

FIG. 5 is a flowchart of a further information processing method provided by an embodiment of the present application;

FIG. 6 is a structural diagram of an information processing apparatus provided by an embodiment of the present application;

FIG. 7 is a structural diagram of another information processing apparatus provided by an embodiment of the present application;

FIG. 8 is a schematic structural diagram of an electronic device provided by an embodiment of the present application.

### DETAILED DESCRIPTION

In order to allow a person skilled in the art to better understand the solution of the present application, with reference to the drawings of the embodiments of the present application, a clear and complete description is given below for the technical solutions of the embodiments of the present application. Obviously, the embodiments described below are only part of the embodiments, rather than all of them. All other embodiments that can be obtained by a person skilled in the art based on the embodiments of the present application without any creative effort fall in the protection scope of the present application.

At present, when an enterprise introduces a third party to provide services for it, it is usually necessary to add a service personnel of the third party to the organizational structure of the enterprise according to the manner of adding an internal personnel, so that the service personnel can provide services for the enterprise. However, this manner of adding makes it impossible for the enterprise to strictly limit permissions of the service personnel, which may easily cause the enterprise to worry about data security and is unfriendly to the serviced enterprise. How to enable the third party to provide services for an enterprise while ensuring data security of the enterprise is an urgent technical problem to be solved.

Based on this, the present application provides an information processing method, which is applied to a first client used by a first user. When a first user needs to introduce a second user, receiving a service order sent by the second user through a second client, the service order comprising an identifier of a second user, an identifier of a first user and a service personnel list. Wherein, the service order is configured for requesting to establish a service association with the first user. In response to receiving the service order and the service order taking effect, establishing an association between the second user and the first user, the association instructing a service personnel in the service personnel list to enter a first client corresponding to the first user as a collaborator, to provide services to the first user in the first client. That is, when the second user provides services for the first user, the service personnel enters the first client as a collaborator, which is convenient for the first user to control his permission, strictly limit his permission in the first client, thus reducing service risks and improving the security of data in the first user.

Wherein, the first client can be an independent client or a target application integrated in a suite of software, such as the first client being an integrated platform in the suite of software used by the first user. When the first client is a target application integrated in a suite of software, and the service personnel of the second user provides services for the first user, the service personnel enters the target application as a collaborator, without the need of entering the organizational structure corresponding to the suite of software used by the first user, but only enters the target application of the suite of software, which will not cause invasion to other applications. Moreover, since the service personnel enters the target application as a collaborator, it is convenient for the first user to control his permission based on the first client, strictly limit his permission in the target application, thus reducing service risks and improving the security of data in the first user. By adding an external service personnel as a collaborator, and controlling permission of the external service personnel when providing services for a first user, data leakage is prevented, and service risk is reduced.

It should be noted that the first client and the second client can be the same type of clients, for example, the first client and the second client are integration platforms, or they can be different types of clients, but information can be transmitted between the two clients.

Wherein, the integration platform is a platform formed by combining integration of application systems with an integration architecture, which solves the problems of high integration cost and low efficiency of enterprises through low construction cost and high integration ability. In this embodiment, the integration platform can integrate multiple systems corresponding to an enterprise, and provide a unified operation portal, so that users can complete corresponding operations through the operation portal without entering respective system to operate, thus improving business processing efficiency. Moreover, the integration platform in the present application can be used as a link for different enterprises to realize communication and establish association for different enterprises.

In particular, a service provider creates a service order in its own corresponding integration platform and sends the service order to an integration platform corresponding to a serviced enterprise. The serviced enterprise can confirm the service order through the integration platform. After the confirmed service order takes effect, the integration platform will establish association between the service provider and the serviced enterprise, so as to add a service personnel in the service provider to the integration platform of the serviced enterprise as a collaborator, and realize control of permission of the service personnel, thus reducing service risks. In the meantime, permission isolation between the service provider and the serviced enterprise is realized through the integration platform to ensure the data security of the serviced enterprise.

In order to facilitate the understanding of the technical solution provided by an embodiment of the present application, the following description will be made with reference to the attached drawings.

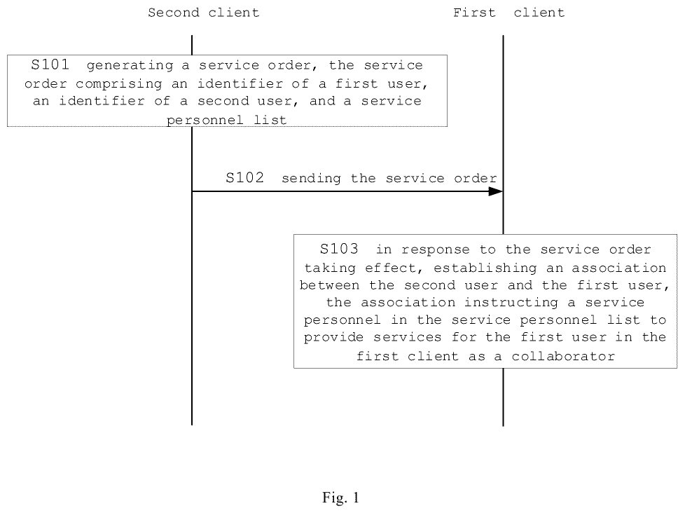

Referring to FIG. 1, which is a flowchart of an information processing method provided by an embodiment of the present application. As shown in FIG. 1, the method can be implemented by an information processing apparatus, which can be a server or an electronic device. Wherein, the electronic device can comprise a mobile phone, a tablet computer, a laptop computer, a desktop computer, a vehicle-mounted terminal, a wearable electronic device, an all-in-one machine, a smart home device and other devices with communication function, and can also be a device simulated by a virtual machine or simulator. As shown in FIG. 1, the method comprises steps of the following:

S101: generating a service order, the service order comprising an identifier of a first user, an identifier of a second user, and a service personnel list.

In this embodiment, after the second user reaches a service intention with the first user, the second user can create a service order through its corresponding second client, so as to establish an association with the first user through the service order request. Wherein, the service order comprises an identifier of a first user, an identifier of a second user and a service personnel list.

The first user identifier may comprise name and trademark of the first user and usage code for using the first client, and the second user identifier may comprise name and trademark of the second user and usage code for using the second client, and so on. The service personnel list may comprise two types of service personnel, one is a service manager, who is the chief person in charge of the service order; another is a service staff, who is the executor of the service order. Wherein, the service order can also include service term and service content. The service term can support positive integers by day, month and year, and the service content is described by the second user itself for the first user to identify and confirm.

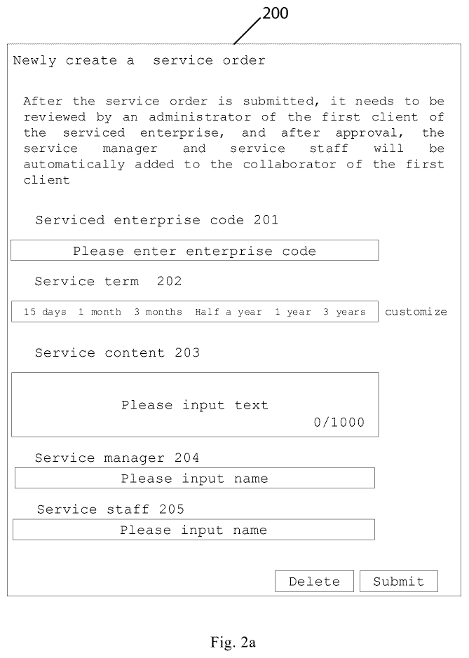

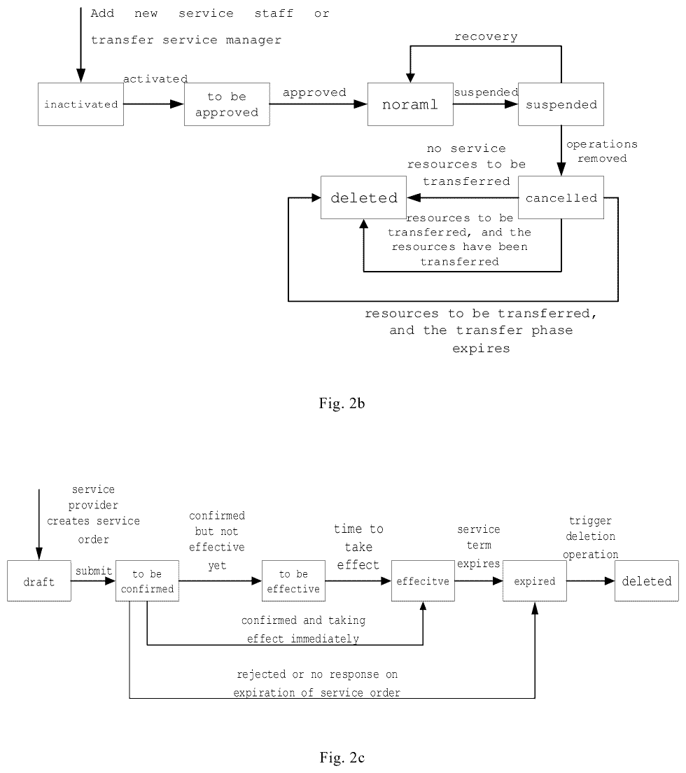

For example, in the schematic diagram of a new service order shown in FIG. 2a, a page 200 for creating a new service order as shown in FIG. 2a includes the following options: serviced enterprise (first user) code (e.g. usage code) option 201, service term option 202, service content option 203, service manager option 204 and service staff option 205. Wherein, the service staff option 205 is optional, and others are required. Wherein, the service term option 202 can provide various service terms, and can also be customized by a creator. Further, a prompt message “After the service order is submitted, it needs to be reviewed by an administrator of the first client of the serviced enterprise, and after approval, the service manager and service staff will be automatically added to the collaborator of the first client” can be displayed on a page for creating a new service order.

S102: sending the service order to the first client.

When the service order is created, the service order is sent to the first client used by the first user, in response to an operation triggered by the creator, so that the first user can authorize the service order. When the second user sends the service order to the first client through the second client, the service order is in a state of “to be signed”. For example, the creator sends the created service order to the first client by clicking a submit button as shown in FIG. 2a.

Wherein, when the second user sends the service order to the first client through the second client, the sent service order is displayed in a service order list of the second client. Wherein, the service order list is configured to show service orders created by the second user and respective first users.

In an embodiment of the present disclosure, for a service order in a pending state, the service order is withdrawn from the first client and deleted from the service order list, in response to a cancellation operation triggered by the second user through the second client.

Wherein, the displaying the created service order in the second client may comprise the following:
When the second user and the first user have one and only one service order, the service order is displayed as “to be signed”;
When the second user and the first user have two service orders, and the current service order is a renewal order of the previous service order, the current service order is displayed as “to be renewed”;
When the second user and the first user have two service orders, but the current service order has no renewal relationship with the previous service order (for example, the service is provided for the second time after a year), the current service order is displayed as “to be signed”.

S103: receiving the service order sent by the second client, and establishing an association between the second user and the first user, in response to the service order taking effect.

When the first client receives the service order, the administrator of the first client needs to confirm the service order. In response to the service order being confirmed and taking effect, establishing the association between the second user and the first user. Wherein, the association instructing a service personnel in the service personnel list to provide services to the first user in the first client as a collaborator.

In an embodiment of the present disclosure, after receiving the service order, in response to the first client receiving a confirmation operation triggered for the service order and a selection operation triggered in the service personnel list, a service personnel is selected from the service personnel list, and the selected service personnel is added as a collaborator of the first client. That is, when the administrator of the first client confirms the service order, some or all service personnels can be selected as collaborators from the service personnel list corresponding to the service order. Wherein, the service manager is a service personnel who must be added, and the service staff can be added optionally.

Wherein, the association between the second user and the first user is established after the service order takes effect. When the service order is confirmed but not yet effective, the service order will be changed from a state of to be signed to a state of to be effective; when it is time to take effect, the state of the service order changes from a to be effective state to an effective state, and here, an association between the second user and the first user is established. When the service order becomes effective immediately after it is confirmed, it will change from the state of to be signed to the state of being effective, and the association between the second user and the first user is established.

When the service order is not confirmed within a preset time, the service order will change from the state of to be signed to an invalid state. For example, if the first user does not confirm the service order within 30 days after receiving it, the service order will be automatically set to the invalid state. Alternatively, when the service term of a service order expires and the service order is not renewed, the service order will be automatically set to the invalid state.

It can be seen that when the first user needs to introduce a third party into the first client used by itself, the second user as the third party sends a service order to the first client of the first user through the second client. The service order comprises an identifier of a second user, an identifier of a first user and a service personnel list. After receiving the service order, in response to the service order taking effect, establishing an association between the second user and the first user, the association instructing a service personnel in the service personnel list to provide services to the first user in the first client as a collaborator. That is, by establishing the association between the second user and the first user, the present application adds the service personnel as a collaborator to the first client used by the first user and limits permission of the service personnel in the first client, thus ensuring the data security of the first user, and reducing service risks.

In an embodiment of the present disclosure, when the service order is in an effective state, the second user can perform an addition or deletion operation for the service personnel corresponding to the service order. In order to facilitate understanding, the above operations will be described from the second user side and the first user side respectively.

### I. Addition of Service Staff

At the second user side, in response to receiving a trigger operation of adding a new service personnel to the service personnel list, sending activation information to a client corresponding to the new service personnel to be added; in response to receiving an operation triggered by receiving the activation information, sending an add request to the first client.

That is, when the second user adds a new service personnel to the service personnel list corresponding to the service order, activation information will be sent to the client of the added new service person, and at this time a state of the service person is “to be activated”. In response to a confirmation operation triggered by the service personnel for the activation information, sending an add request to the first client, whereby the state of the service personnel is changed from “to be activated” to “to be approved”. For example, the “service manager” corresponding to the service order adds another staff in the second user as “a service staff” for the service order.

In an embodiment of the present disclosure, in response to not receiving a trigger operation for activation information within a second preset time, deleting the added new service personnel from the service personnel list.

On the first user side, in response to receiving an add request and a confirmation operation triggered for the add request, determining the added new service personnel as a collaborator of the first client. Then, the service personnel provides services to the first user in the first client as a collaborator. Here, the service personnel's state will be changed from “to be approved” to “normal”.

In an embodiment of the present disclosure, in response to a rejection operation triggered for the add request or no operation triggered for the add request within a first preset time, deleting the added new service personnel from the service personnel list. That is, when the first user rejects the add request, the service personnel is deleted from the service personnel list. Or, when the add request is not approved within the first preset time, it is automatically determined as rejecting the add request, and the service personnel is deleted from the service personnel list. For example, if the add request is not approved within 30 days, it is automatically determined that the add request is rejected. Wherein, both the second client and the first client execute the deletion operation.

### II. Deletion of Service Staff

In response to a target service personnel terminating service relationship with the first user, canceling a collaborator identity of the target service personnel; deleting the target service personnel from the service personnel list. Wherein, the target service personnel comprises one or more service personnels in the service personnel list corresponding to the service order.

Usually, the target service personnel will create or manage some service resources when providing services for the first user in the first client. In order to ensure that the service resources will not be lost, when the target service personnel terminates service relationship with the first user, a service resource transfer period will be reserved, so that the target service personnel can complete the service resource transfer during the service resource transfer period. In response to the transfer of the service resources managed by the target service personnel, canceling the collaborator identity of the target service personnel, so that the target service personnel no longer has the permission to log onto the first client. Wherein, the target service personnel can only transfer and view the service resources during the service resource transfer period, and cannot create, edit or delete the transferred resources, nor can he start or stop a resource transfer operation or the like.

Wherein, the target service personnel terminating service relationship with the first user may comprise one or more of the following: the service order expires and is not renewed within a specified time, the target service personnel terminates service relationship with the second user, the target service personnel is removed from the service personnel list by the first user or the target service personnel is removed from the service personnel list by the second user. Wherein, when the service order expires and is not renewed within the specified time, the target service personnel comprises all the personnels in the service order.

In an embodiment of the present disclosure, on the first user side, in response to receiving a suspension operation triggered for an account of the target service personnel, setting the account of the target service personnel to a suspended state. Wherein, the account of the target service personnel is configured for logging onto the first client. That is, the administrator of the first user can suspend the account of the target service personnel at a control level of a target application, so that the account of the target service personnel is in a “suspended” state, thereby facilitating the first user to manage collaborators and reducing service risks. For the target service personnel whose account is in the “suspended” state, he cannot perform any service operation in the first client.

In one embodiment of the present disclosure, in response to receiving a recovery operation triggered for the account of the target service personnel, setting the account of the target service personnel to the normal state, so that the target service personnel logs onto the first client with the account to provide services for the first user.

In order to understand the state change of service personnel in the first client, one may refer to the state transition diagram shown in FIG. 2b, and the specific transition process is as follows:
When a new service staff is added or a service manager is transferred, the account of the service personnel enters an inactive state;
When the service personnel is activated, a state “to be approved” is entered;
After the administrator of the first client reviews and approves, the account of the service personnel enters a normal state;
When the account of the service personnel is suspended by the administrator, it enters the suspended state;
When the recovery operation is triggered, the account enters the normal state;
When the removal operation is triggered, canceling the collaborator identity of the service personnel, and if there are no service resources to be transferred, the first client automatically deletes the service personnel; if there are service resources to be transferred, the service personnel will be automatically deleted after all the service resources are transferred; if the service resource transfer period expires, the service personnel will be automatically deleted.

In one embodiment of the present disclosure, displaying a collaborator list, the collaborator list comprising service personnels in the service personnel list. That is, in response to the administrator of the first client triggering an operation of viewing the collaborator list, the collaborator list is displayed, so that the administrator can view one or more added collaborators through the collaboration list.

Wherein, the collaborator list may comprise not only the service personnel of the second user, but also the personnel of the first user. In order to effectively distinguish two different types of collaborators, the collaborator list also comprises an external identifier configured to indicate that the service personnel of the second user is an external collaborator. When the first user corresponds to a plurality of second users, in order to enable the administrator to effectively distinguish the second users to which different collaborators belong in the collaborator list, the collaborator list also comprises an identifier of a second user.

In one embodiment of the present disclosure, deleting the association in response to the service order being in an invalid state. That is, when the service order changes from the effective state to the invalid state, the association between the second user and the first user will be automatically deleted, so that the service personnel corresponding to the service order will be automatically removed from the collaborator list of the first client.

In one embodiment of the present disclosure, the service personnel usually creates service resources in the first client when providing services for the first user. In order to ensure smooth transfer of service resources when the service order is in the invalid state, a resource transfer phase with a preset time period will be reserved, in which the service personnel can transfer the service resources he manages to the administrator of the first client. Based on this, in response to the service order being in the invalid state and the service resources corresponding to the service order having been transferred to the first user, deleting the association. That is, the association is not deleted until the service resources corresponding to the service order are transferred to the first user, to avoid the loss of service resources caused by immediate deletion of the association due to the invalidation of the service order. For example, when a service order is in the invalid state, the service order enters a 15-day service resource transfer phase, and the service personnel needs to transfer the service resources to the first user within 15 days. At the end of the 15-day transfer period, the association will be automatically deleted, and the service resources that have not been transferred in time will be automatically transferred.

Wherein, since the service order is in an invalid state during the resource transfer, in order to reduce the service risk, operation of the service personnel in the first client will be restricted, and prohibited operations may comprise: new service personnel cannot be added to the service personnel list, and the service personnel in the service personnel list cannot create, edit, delete or share the service resources, or the like.

Referring to the diagram of state transition of a service order shown in FIG. 2c, first, a second user creates a service order based on a second client, and after submitting the service order, the service order is in a state of “to be confirmed”; when the first user confirms through the first client and an effective time is not reached, it enters a to-be-effective state; when the first user confirms through the first client and it takes effect immediately, it enters an effective state. If the service order is confirmed or rejected by the first user, it will enter an invalid state, or the effective service order will enter the invalid state, if not renewed upon expiration. For an invalid service order, the first user or the second user can implement a deletion operation, and then, the service order is deleted.

In one embodiment of the present disclosure, generating a renewal order in response to imminent expiration of a service term of the service order; sending the renewal order to the first client. Wherein, an effective time of the renewal order is later than an expiration time of the service order. For example, the effective time of the renewal order is the next day of the expiration time of the service order.

Wherein, when the service term of the service order is about to expire, the first client can send a reminder message to the second client to remind the second user to renew the order as soon as possible. For example, the first client sends a message to the client of the service manager to remind the service manager to create a renewal order. If the service term expires and is not renewed, the service order will be in the invalid state.

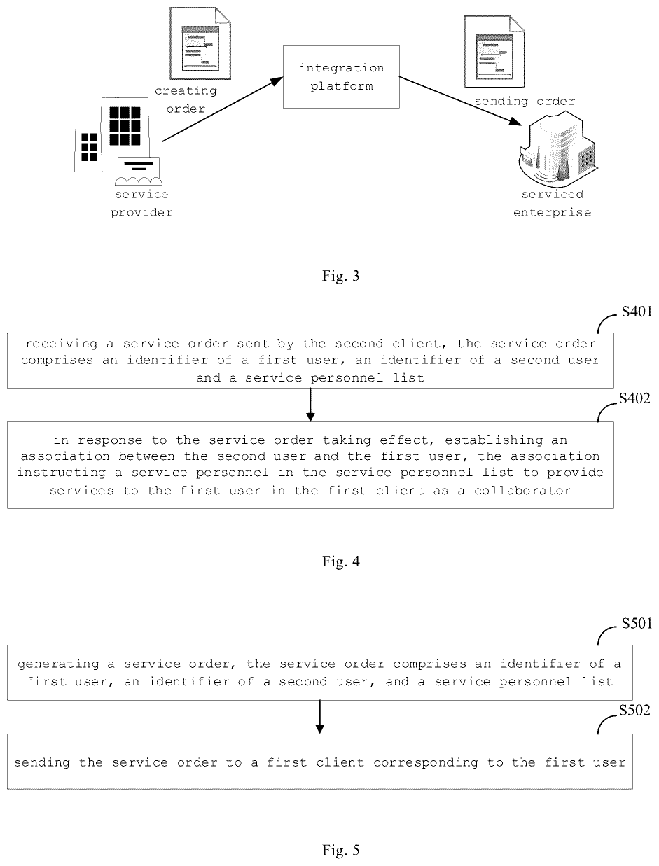

For the convenience of understanding the present application, one may refer to the schematic diagram of the application scenario shown in FIG. 3. As shown in FIG. 3, the second user is a service provider and the first user is a serviced enterprise, and they can establish an association through an integration platform. In particular, both the service provider and the serviced enterprise have applied for login accounts with the integration platform, and access the integration platform through their respective login accounts. Wherein, the service provider creates a service order in its own corresponding integration platform and sends the service order to the integration platform corresponding to the serviced enterprise. The serviced enterprise can confirm the service order through the integration platform. After the confirmed service order takes effect, the integration platform establishes an association between the service provider and the serviced enterprise, so as to add a service staff in the service provider to the integration platform of the serviced enterprise as a collaborator, thereby realizing control of permission of the service staff and reducing service risks.

FIG. 4 is a flowchart of an information processing method provided by an embodiment of the present application, which applies to the fist client and may comprise:

S401: receiving a service order sent by the second client.

Wherein, the service order comprises an identifier of a first user, an identifier of a second user and a service personnel list. The first client corresponds to the first user, the second client corresponds to the second user, the second user provides services for the first user. For specific implementation of S401 in the embodiment, one may refer to the related description of the above-mentioned S102 and S103.

S402: In response to the service order taking effect, establishing an association between the second user and the first user.

Wherein, the association instructing a service personnel in the service personnel list to provide services to the first user in the first client, as a collaborator. For specific implementation of S402 in the embodiment, one may refer to the related description of the above-mentioned S103.

In one embodiment of the present disclosure, after receiving the service order, the method further comprises: in response to receiving a confirmation operation triggered for the service order and a selection operation triggered in the service personnel list, a service personnel is selected from the service personnel list, and the selected service personnel is added as a collaborator of the first client.

In one embodiment of the present disclosure, the method further comprises: in response to receiving an add request for adding a new service personnel in the service personnel list and a confirmation operation triggered for the add request, determining the added new service personnel as a collaborator of the first client.

In one embodiment of the present disclosure, the method further comprises: in response to a rejection operation triggered for the add request or no operation triggered for the add request within a first preset time, deleting the added new service personnel from the service personnel list.

In one embodiment of the present disclosure, the method further comprises: in response to a target service personnel terminating service relationship with the first user, canceling a collaborator identity of the target service personnel. Wherein, the target service personnel comprises one or more service personnels in the service personnel list; deleting the target service personnel from the service personnel list.

In one embodiment of the present disclosure, the canceling a collaborator identity of the target service personnel, in response to a target service personnel terminating service relationship with the first user, comprises: in response to the target service personnel terminating service relationship with the first user and service resources managed by the target service personnel having been transferred, canceling the collaborator identity of the target service personnel.

In one embodiment of the present disclosure, the target service personnel terminating service relationship with the first user comprises one or more of the following: the service order expires and is not renewed within a specified time, the target service personnel terminates service relationship with the second user, the target service personnel is removed from the service personnel list by the first user, the target service personnel is removed from the service personnel list by the second user.

In one embodiment of the present disclosure, the method further comprises: in response to receiving a suspension operation triggered for an account of the target service personnel, setting the account of the target service personnel to a suspended state. Wherein, the account is configured for the target service personnel to log onto the first client.

In one embodiment of the present disclosure, the method further comprises: in response to receiving a recovery operation triggered for the account of the target service personnel, setting the account of the target service personnel to a normal state, so that the target service personnel logs onto the first client with the account to provide services for the first user.

In one embodiment of the present disclosure, the method further comprises: displaying a collaborator list, the collaborator list comprising service personnels in the service personnel list.

In one embodiment of the present disclosure, the collaborator list further comprises an external identifier configured to indicate that the service personnel is an external collaborator.

In one embodiment of the present disclosure, the method further comprises: deleting the association in response to the service order being in an invalid state.

In one embodiment of the present disclosure, the deleting the association in response to the service order being in the invalid state, comprises: in response to the service order being in the invalid state and the service resources corresponding to the service order having been transferred to the first user, deleting the association.

In one embodiment of the present disclosure, during the transfer of the service resources corresponding to the service order, prohibited operations comprise: a new service personnel cannot be added to the service personnel list, and the service personnel in the service personnel list cannot create, edit, delete or share the service resources.

It should be noted that, for implementation of the above-mentioned embodiments, one can refer to the related description of FIG. 1, FIG. 2a, FIG. 2b and FIG. 2c.

FIG. 5 is a flowchart of another information processing method provided by an embodiment of the present application, which applies to the second client and may comprise:

S501: generating a service order.

Wherein, the service order comprises an identifier of a first user, an identifier of a second user, and a service personnel list, the second user corresponding to the second client, the second user providing services for the first user. For specific implementation of S501, one may refer to the related description of the above-mentioned S101. The description thereof will not be repeated here for this embodiment.

S502: sending the service order to a first client corresponding to the first user.

When the service order is created, the service order is sent to the first client used by the first user, in response to a send operation triggered by the creator, so that the first user can confirm the service order. For specific implementation of S502, one may refer to the related description of the above-mentioned S102.

In one embodiment of the present disclosure, the method further comprises: in response to receiving a confirmation operation triggered for the service order and an effective time of the service order is reached, determining that the service order is in an effective state.

In one embodiment of the present disclosure, generating a renewal order in response to imminent expiration of a service term of the service order. Wherein the effective time of the renewal order is later than the expiration time of the service order; renewing the order with the first client.

In one embodiment of the present disclosure, the method further comprises: in response to receiving a trigger operation of adding a new service personnel to the service personnel list, sending activation information to a client corresponding to the new service personnel to be added; in response to receiving an operation triggered by the activation information, sending an add request to the first client.

In one embodiment of the present disclosure, the method further comprises: in response to not receiving a trigger operation for the activation information within a second preset time, deleting the added new service personnel from the service personnel list.

In one embodiment of the present disclosure, the method further comprises: in response to receiving a rejection operation triggered for the add request or receiving no trigger operation for the add request within a first preset time, deleting the added new service personnel from the service personnel list.

It should be noted that for implementation of the above-mentioned embodiments, one can refer to the related description of FIG. 1, FIG. 2a, FIG. 2b and FIG. 2c.

Based on the above method embodiment, an embodiment of the present application provides an information processing apparatus and device, which will be described below with reference to the attached drawings.

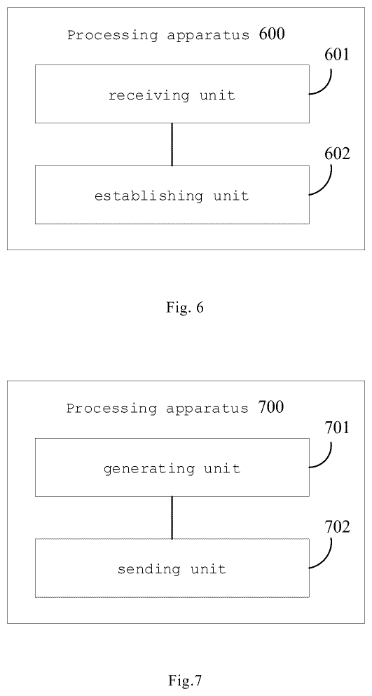

Referring to FIG. 6, which shows an information processing apparatus provided by an embodiment of the present application. The apparatus 600, which can be applied to the first client, comprises: a receiving unit 601 and an establishing unit 602.

The receiving unit 601 is configured for receiving a service order sent by a second client, the service order comprising an identifier of a first user, an identifier of a second user, and a service personnel list, the first client corresponding to the first user, the second client corresponding to the second user, the second user providing services for the first user.

The establishing unit 602 is configured for, in response to the service order taking effect, establishing an association between the second user and the first user, the association instructing a service personnel in the service personnel list is able to provide services to the first user in the first client as a collaborator.

In one embodiment of the present disclosure, the apparatus further comprises: an adding unit.

The adding unit is configured for, after receiving the service order, in response to receiving a confirmation operation triggered for the service order and a selection operation triggered in the service personnel list, selecting a service personnel from the service personnel list, and adding the selected service personnel as a collaborator of the first client.

In one embodiment of the present disclosure, the apparatus further comprises: a determining unit.

The determining unit is configured for, in response to receiving an add request for adding a new service personnel in the service personnel list and a confirmation operation triggered for the add request, determining the added new service personnel as a collaborator of the first client.

In one embodiment of the present disclosure, the apparatus further comprises: a deleting unit.

The deleting unit is configured for, in response to a rejection operation triggered for the add request or no operation triggered for the add request within a first preset time, deleting the added new service personnel from the service personnel list.

In one embodiment of the present disclosure, the apparatus further comprises: a canceling unit and a deleting unit.

The canceling unit is configured for, in response to a target service personnel terminating service relationship with the first user, canceling a collaborator identity of the target service personnel, wherein the target service personnel comprises one or more service personnels in the service personnel list.

The deleting unit is configured for deleting the target service personnel from the service personnel list.

In one embodiment of the present disclosure, the canceling unit is further configured particularly for, in response to the target service personnel terminating service relationship with the first user and service resources managed by the target service personnel having been transferred, canceling the collaborator identity of the target service personnel.

In one embodiment of the present disclosure, the target service personnel terminating service relationship with the first user comprises one or more of the following: the service order expires and is not renewed within a specified time, the target service personnel terminates service relationship with the second user, the target service personnel is removed from the service personnel list by the first user, the target service personnel is removed from the service personnel list by the second user.

In one embodiment of the present disclosure, the apparatus further comprises: a confirming unit.

The confirming unit is configured for, in response to receiving a suspension operation triggered for an account of the target service personnel, setting the account of the target service personnel to a suspended state, wherein, the account is configured for the target service personnel to log onto the first client.

In one embodiment of the present disclosure, the confirming unit is further configured for, in response to receiving a recovery operation triggered for the account of the target service personnel, setting the account of the target service personnel to a normal state, so that the target service personnel logs onto the first client with the account to provide services for the first user.

In one embodiment of the present disclosure, the apparatus further comprises: a displaying unit.

The displaying unit is configured for displaying a collaborator list, the collaborator list comprising service personnels in the service personnel list.

In one embodiment of the present disclosure, the collaborator list further comprises an external identifier configured to indicate that the service personnel is an external collaborator.

In one embodiment of the present disclosure, the apparatus further comprises: a deleting unit.

The deleting unit is configured for deleting the association in response to the service order being in an invalid state.

In one embodiment of the present disclosure, the deleting unit is configured particularly for, in response to the service order being in the invalid state and the service resources corresponding to the service order having been transferred to the first user, deleting the association.

In one embodiment of the present disclosure, during the transfer of the service resources corresponding to the service order, prohibited operations comprise: a new service personnel cannot be added to the service personnel list, and the service personnel in the service personnel list cannot create, edit, delete and share the service resources.

Referring to FIG. 7, which is a structural diagram of another information processing apparatus provided by an embodiment of the present application. The apparatus 700, which can be applied to the second client, comprises: a generating unit 701 and a sending unit 702.

The generating unit 701 is configured for generating a service order, the service order comprising an identifier of a first user, an identifier of a second user, and a service personnel list, the second user corresponding to the second client, the second user providing services for the first user.

The sending unit 702 is configured for sending the service order to a first client corresponding to the first user.

In one embodiment of the present disclosure, the apparatus further comprises: a determining unit.

The determining unit is configured for, in response to receiving a confirmation operation triggered for the service order and an effective time of the service order is reached, determining that the service order is in an effective state.

In one embodiment of the present disclosure, the generating unit 701 is further configured for generating a renewal order in response to imminent expiration of a service term of the service order, wherein an effective time of the renewal order is later than an expiration time of the service order.

The sending unit 702 is further configured for sending the renewal order to the first client.

In one embodiment of the present disclosure, the sending unit 702 is further configured for, in response to receiving a trigger operation of adding a new service personnel to the service personnel list, sending activation information to a client corresponding to the new service personnel to be added; in response to receiving an operation triggered for the activation information, sending an add request to the first client.

In one embodiment of the present disclosure, the apparatus further comprises: a deleting unit.

The deleting unit is configured for, in response to not receiving an operation triggered for the activation information within a second preset time, deleting the service personnel from the service personnel list.

In one embodiment of the present disclosure, the apparatus further comprises: a deleting unit.

The deleting unit is configured for, in response to receiving a rejection operation triggered for the add request or receiving no operation triggered for the add request within a first preset time, deleting the added new service personnel from the service personnel list.

It should be noted that, for specific implementation of each unit in the above-mentioned apparatus embodiment, one can refer to the related description in the above-mentioned method embodiments. The division of units in the embodiment of the present application is schematic, it is only a logical function division, and there may be other division methods in actual implementation. Individual functional units in an embodiment of the present disclosure may be integrated into one processing unit, or individual units may exist physically alone, or two or more units may be integrated into one unit. For example, in the above embodiments, the processing unit and the sending unit may be the same unit or different units. The above integrated units can be realized in the form of hardware or software functional units.

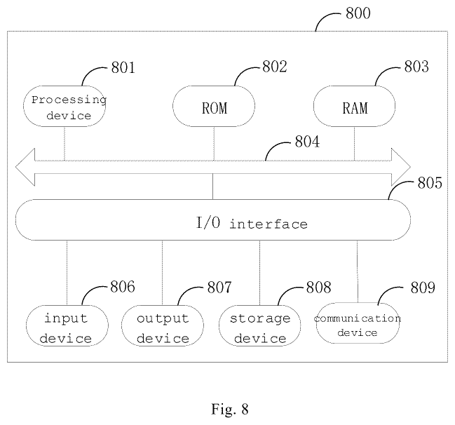

FIG. 8 shows a structural schematic diagram of an electronic device 800 adapted for implementing an embodiment of the present disclosure. The terminal equipment in the embodiment of the present disclosure may include, but is not limited to, a mobile terminal such as a mobile phone, a laptop computer, a digital broadcast receiver, a Personal Digital Assistant (PDA), a Tablet Computer (PAD), a Portable Multimedia Player (PMP), a vehicle-mounted terminal (such as a vehicle-mounted navigation terminal) and the like, and a fixed terminal such as a digital TV, a desktop computer and the like. The electronic device shown in FIG. 8 is only an example, and should not be construed to limit function and application scope of the embodiment of the present disclosure.

As shown in FIG. 8, an electronic device 800 may include a processing device (e.g., a central processing unit, a graphics processing unit, etc.) 801, which may perform various appropriate actions and processes according to a program stored in a read-only memory (ROM) 802 or a program loaded into a random access memory (RAM) 803 from a storage device 808. In the RAM 803, various programs and data required for operation of the electronic apparatus 800 are also stored. The processing device 801, the ROM 802 and the RAM 803 are connected to each other through a bus 804. An input/output (I/O) interface 805 is also connected to the bus 804.

Generally, the following devices can be connected to the I/O interface 805: an input device 806 including, for example, a touch screen, a touch pad, a keyboard, a mouse, a camera, a microphone, an accelerometer, a gyroscope, etc.; an output device 807 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wiredly with other devices to exchange data. Although FIG. 8 shows an electronic device 800 with various devices, it should be understood that it is not required to implement or have all the devices shown. More or fewer devices may alternatively be implemented or provided.

In particular, according to an embodiment of the present disclosure, the process described above with reference to the flowcharts can be implemented as a computer software program. For example, the embodiment of the present disclosure comprises a computer program product comprising a computer program carried on a non-transitory computer-readable medium, the computer program including program code for executing the method shown in the flow charts. In such an embodiment, the computer program can be downloaded and installed from the network through the communication device 809, or installed from the storage device 808, or installed from the ROM 802. When the computer program is executed by the processing device 801, the above functions defined in the method of the embodiment of the present disclosure is performed.

The electronic apparatus provided by the embodiment of this disclosure belongs to the same inventive concept as the method provided by the above embodiment, and the technical details not described in detail in this embodiment can be found in the above embodiments, and this embodiment has the same advantageous effects as the above embodiments.

An embodiment of the present disclosure provides a computer storage medium, on which a computer program is stored, and the computer program, when executed by a processor, implements the methods provided by the above-mentioned embodiments.

It should be noted that the computer-readable medium mentioned above in this disclosure can be a computer-readable signal medium or a computer-readable storage medium or any combination thereof. The computer-readable storage medium can be, for example, but not limited to, an electrical, magnetic, optical, electromagnetic, infrared, or semiconductor system, device or unit, or any combination of the above. More examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which program can be used by or in combination with an instruction execution system, device or unit. In the present disclosure, a computer-readable signal medium may include a data signal propagated in baseband or as part of a carrier wave, in which computer-readable program code is carried. This propagated data signal can take many forms, including but not limited to an electromagnetic signal, an optical signal or any suitable combination of the above. A computer-readable signal medium can also be any computer-readable medium other than a computer-readable storage medium, which can send, propagate or transmit a program for use by or in connection with an instruction execution system, device or unit. Program code contained in the computer-readable medium can be transmitted by any suitable medium, including but not limited to: a wire, an optical cable, a radio frequency (RF) and the like, or any suitable combination of the above.

In some embodiments, the client and the server can communicate by using any currently known or future developed network protocol such as HyperText Transfer Protocol (HTTP), and can be interconnected with digital data communication in any form or medium (for example, communication network). Examples of communication network include a local area network (“LAN”), a wide area network (“WAN”), an internet (for example, the Internet) and an end-to-end network (for example, ad hoc end-to-end network), as well as any currently known or future developed network.

The computer-readable medium may be included in the electronic device; or it can exist independently without being assembled into the electronic device.

The computer-readable medium carries one or more programs, which, when executed by the electronic device, cause the electronic device to perform the methods of the present disclosure.

Computer program codes for performing operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowcharts or block diagrams may represent a module, a program segment, or part of codes that contains one or more executable instructions for implementing a specified logical function. It should also be noted that in some alternative implementations, the functions noted in the blocks may occur in a different order than that noted in the drawing. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

Units involved in the embodiments described in the present disclosure can be realized by software or hardware. Wherein, names of units/modules do not constitute limitation of the units themselves in some cases.

Functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, device or apparatus. The machine-readable medium may be a machine-readable signal medium or a machine-readable storage medium. A machine-readable medium may include, but is not limited to, an electronic, magnetic, optical, electromagnetic, infrared, or semiconductor system, device or apparatus, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

It should be noted that each embodiment in this description is described in a progressive way, and each embodiment is described by focusing on the differences from other embodiments, so that for the same and similar parts between each embodiment, it is only necessary to refer to other embodiments. As for the system or apparatus disclosed in the embodiments, since it corresponds to the methods disclosed in the embodiments, the description is relatively simple, and the relevant points can be found in the description for the methods.

It should be understood that in the present application, “at least one” means one or more, and “multiple” means two or more. “And/or” only describes an associative relationship, which means that there can be three kinds of relationships, for example, A and/or B, which can mean that A exists alone, B exists alone and A and B exist at the same time, where A and B can be singular or plural. The sign “/” generally indicates that the objects before and after are in an “or” relationship. The term “at least one of the following” or its similar expression refers to any combination of these items, including single items or any combination of multiple items. For example, at least one of a, b, or c can be represented as a, b, c, “a and b”, “a and c”, “b and c”, or “a and b and c”, where a, b, and c can be single or multiple.

It should be noted that in this context, relational terms such as “first” and “second” are only used to distinguish one entity or operation from another entity or operation, and do not necessarily require or imply that there is any such actual relationship or order between these entities or operations. Moreover, terms “comprising”, “including” or any other variation thereof are intended to cover non-exclusive inclusion, so that a process, method, article or apparatus including a series of elements includes not only those elements, but also other elements not explicitly listed or elements inherent to such process, method, article or apparatus. Without further restrictions, an element defined by the phrase “comprising a . . . ” does not exclude the existence of other identical elements in the process, method, article or apparatus comprising the element.

The steps of a method or algorithm described in conjunction with the embodiments disclosed herein can be directly implemented using hardware, software modules executed by a processor, or a combination of both. The software modules can be placed in random access memory (RAM), internal memory, read-only memory (ROM), electrically programmable ROM, electrically erasable programmable ROM, register, hard disk, removable disk, CD-ROM, or any other storage medium known in the technical field.

The foregoing description of the disclosed embodiments enables those skilled in the art to implement or use the present application. Many modifications to these embodiments will be obvious to those skilled in the art, and the general principles defined herein can be implemented in other embodiments without departing from the spirit or scope of the present application. Therefore, the present application will not be limited to the embodiments described herein, but is to be accorded the widest scope consistent with the principles and novel features disclosed herein.

1. An information processing method, applied to a first client, comprising:
receiving a service order sent by a second client, the service order comprising an identifier of a first user, an identifier of a second user, and a service personnel list, the first client corresponding to the first user, the second client corresponding to the second user, the second user providing services for the first user;
in response to the service order taking effect, establishing an association between the second user and the first user, the association instructing a service personnel in the service personnel list is able to provide services for the first user in the first client as a collaborator.

2. The method according to claim 1, wherein after receiving the service order, the method further comprising:
in response to receiving a confirmation operation triggered for the service order and a selection operation triggered in the service personnel list, selecting a service personnel from the service personnel list, and
adding the selected service personnel as a collaborator of the first client.

3. The method according to claim 1, the method further comprising at least one of:
in response to receiving an add request for adding a new service personnel in the service personnel list and a confirmation operation triggered for the add request, determining the added new service personnel as a collaborator of the first client; or
in response to a rejection operation triggered for the add request or no operation triggered for the add request within a first preset time, deleting the added new service personnel from the service personnel list.

4. (canceled)

5. The method according to claim 1, the method further comprising:
in response to a target service personnel terminating service relationship with the first user, canceling a collaborator identity of the target service personnel, wherein the target service personnel comprises one or more service personnels in the service personnel list;
deleting the target service personnel from the service personnel list.

6. The method according to claim 5, wherein the canceling a collaborator identity of the target service personnel, in response to a target service personnel terminating service relationship with the first user, comprises:
in response to the target service personnel terminating service relationship with the first user and service resources managed by the target service personnel having been transferred, canceling the collaborator identity of the target service personnel.

7. The method according to claim 5, wherein the target service personnel terminating service relationship with the first user comprises one or more of:
the service order expires and is not renewed within a specified time, the target service personnel terminates service relationship with the second user, the target service personnel is removed from the service personnel list by the first user, the target service personnel is removed from the service personnel list by the second user.

8. The method according to claim 1, wherein the method further comprising at least one of:
In response to receiving a suspension operation triggered for an account of the target service personnel, setting the account of the target service personnel to a suspended state, wherein, the account is configured for the target service personnel to log onto the first client; or
in response to receiving a recovery operation triggered for the account of the target service personnel, setting the account of the target service personnel to a normal state, so that the target service personnel logs onto the first client with the account to provide services for the first user.

9. (canceled)

10. The method according to claim 1, the method further comprising:
displaying a collaborator list, the collaborator list comprising service personnels in the service personnel list.

11. The method according to claim 10, wherein the collaborator list further comprises an external identifier configured to indicate that the service personnel is an external collaborator.

12. The method according to claim 1, the method further comprising:
deleting the association in response to the service order being in an invalid state.

13. The method according to claim 12, wherein the deleting the association in response to the service order being in an invalid state, comprises:
in response to the service order being in the invalid state and the service resources corresponding to the service order having been transferred to the first user, deleting the association.

14. The method according to claim 13, wherein during the transfer of the service resources corresponding to the service order, prohibited operations comprise: a new service personnel cannot be added to the service personnel list, the service personnel in the service personnel list cannot create, edit, delete or share the service resources.

15. An information processing method, applied to a second client, comprising:
generating a service order, the service order comprising an identifier of a first user, an identifier of a second user, and a service personnel list, the second user corresponding to the second client, the second user providing services for the first user;
sending the service order to a first client corresponding to the first user.

16. The method according to claim 15, the method further comprising at least one of:
in response to receiving a confirmation operation triggered for the service order and an effective time of the service order is reached, determining that the service order is in an effective state; or
generating a renewal order in response to imminent expiration of a service term of the service order, wherein an effective time of the renewal order is later than an expiration time of the service order; sending the renewal order to the first client.

17. (canceled)

18. The method according to claim 16, the method further comprising:
in response to receiving a trigger operation of adding a new service personnel to the service personnel list, sending activation information to a client corresponding to the new service personnel to be added;
in response to receiving an operation triggered for the activation information, sending an add request to the first client.

19. The method according to claim 18, the method further comprising at least one of:
in response to not receiving an operation triggered for the activation information within a second preset time, deleting the service personnel from the service personnel list; or
in response to receiving a rejection operation triggered for the add request or receiving no operation triggered for the add request within a first preset time, deleting the added new service personnel from the service personnel list.

20. (canceled)

21. (canceled)

22. (canceled)

23. An electronic device, the device comprises: a processor and a memory;
wherein the memory is configured for storing instructions or a computer program; and
the processor is configured for executing the instructions or computer program in the memory, to cause the electronic device to implement an information processing method, applied to a first client, comprising:
receiving a service order sent by a second client, the service order comprising an identifier of a first user, an identifier of a second user, and a service personnel list, the first client corresponding to the first user, the second client corresponding to the second user, the second user providing services for the first user;
in response to the service order taking effect, establishing an association between the second user and the first user, the association instructing a service personnel in the service personnel list is able to provide services for the first user in the first client as a collaborator.

24. A non-transitory computer-readable storage medium, having instructions stored thereon, the instructions, when executed by a device, cause the device to implement the method according to claim 1.

25. (canceled)

26. An electronic device, the device comprises: a processor and a memory;
wherein the memory is configured for storing instructions or a computer program; and
the processor is configured for executing the instructions or computer program in the memory, to cause the electronic device to implement the method according to claim 15.

27. A non-transitory computer-readable storage medium, having instructions stored thereon, the instructions, when executed by a device, cause the device to implement the method according to claim 15.
